(19) United States
(12) Patent Application Publication
(10) Pub. No.: US 2008/0033783 A1
(43) Pub. Date: Feb. 7, 2008

(54) System and Method of Retaining Customers

(75) Inventors: Hillard Tyree, Hamilton, OH (US); Kasey R. Princell, Oxford, OH (US)

Correspondence Address: ADVANTIA LAW GROUP, 9035 SOUTH 1300 EAST, SUITE 200, SANDY, UT, 84094, US

(73) Assignee: PRINCE TREE LLC, Hamilton, OH (US)

(21) Appl. No.: 11/461,721

(22) Filed: Aug. 1, 2006

(51) Int. Cl. G06F 17/30

(52) U.S. Cl. 705/10

(57) ABSTRACT

A method and system of retaining a customer. Steps include: providing a first motor and a first implement to a customer with more implements as a kit; and offering for sale a second implement. The implements are each removably coupleable to the motor without tools. There is a storage device for holding implements in a folded storage mode. The storage device includes a winch for holding the motor. There is a suggestive indicator suggesting a purchase. Other steps include: gather demand data; determining sets of implements having related demand; recording providing the first motor to an identified customer; recording providing the first implement to the identified customer; and conditionally offering a benefit to the identified customer upon purchase of the second implement. Motors are horizontal and vertical. There is a repair system for exchanging identical motors for use in the system.

### BACKGROUND OF THE INVENTION

1. Field of the Invention

The present invention relates to systems and methods of retaining customers, specifically to methods of retaining customers of motorized devices.

2. Description of the Related Art

In the related art, it has been known to provide a variety of motorized devices/tools to customers to empower customers. Virtually every garage has one or more implements, such as lawn mowers, leaf blowers, snow blowers, weed-eaters, electricity generators, etc. These devices/implements are of substantial assistance in providing for a great variety of maintenance needs of property owners.

However, while these devices may vary greatly in purpose, shape, components, and/or design, they each have an attached motor. Further, it is rare for the various devices to be used simultaneously, especially in the context of personal use. More, some of the devices are used seasonally (such as a snow blower) wherein a device may go several months without use. Motors function best during regular use. Therefore, during extended down-time a motor may suffer damage from time or the elements. Further, as warrantee duration for these implements are generally measured in time elapsed (e.g. 3 year warrantee) instead of time of use (e.g. 500 hours of run-time), warrantee providers and consumers unfairly face an extremely varied amount of protection.

Also, as needs and resources change for a particular customer, opportunities arise to provide the customer with additional motored implements. While brand loyalty may drive a consumer to purchase another implement within a product line, many customers view the purchase of each new implement as a distinct and separate transaction. Accordingly, each manufacturer is in substantially equal footing with regard to attracting customers. Wherein each implement stands on its own in competition for customer dollars, customer acquisition costs repeat and must be factored into the price of the implements themselves.

Accordingly, advances have been made in trying to provide customers with better implements and to retain customers for subsequent implement purchases. Examples include but are not limited to the references described below, which references are incorporated by reference herein:

U.S. Pat. No. 6,722,445 to Ohta et al. discloses a front-rotary working machine employing a vertical engine having an output shaft projecting downward, and a transmission case, provided beneath the vertical engine, has a flat underside so as to extend generally parallel to the ground surface to be cultivated. Distance between left and right transporting wheels, connected to a driving shaft at a rear end portion of the transmission case, can be reduced as necessary.

U.S. Pat. No. 6,606,845 to Spies discloses a plurality of modular-construction hand-operated motorized devices, including a lawn mower, a verticutting implement, a sweeping device, and a device for loosening the soil or taking in and blowing out leaves are disclosed. Each device includes a limited number of differently designed and dimensioned main and additional modules which provide for a wide range of individually adapted types of devices to be constructed.

U.S. Pat. No. 4,453,372 by Remer discloses a universal grass edger and trimmer attachment is disclosed utilizing a rotary flexible drive shaft whose operating end is supported by a multi-positional boom.

U.S. Pat. No. 4,642,976 by Owens discloses a cutting head and mounting assembly for adjustably supporting the cutting head on a mower. The mounting assembly for the head permits easy adjustment of the height of the head above the ground, its horizontal angle with respect to the frame of the mower, and the inclination of the head from a horizontal to a vertical orientation or any angle of inclination therebetween. At the end of the head opposite its cutting flail members, there is a quick detach joint which allows, either an electric motor to be mounted and energized through a switch by electrical power available aboard the mower, or alternatively allows a cable drive to be mounted which drives the head from a friction drive mechanism taking power from the mower engine shaft, the friction drive being selectively engageable by means of a Bowden control cable. A guard to deflect cuttings away from the operation is mounted on the cutting head.

U.S. Pat. No. 4,718,221 by Wessel et al. discloses a rotary lawnmower has an edger/trimmer including a freely rotatable disk disposed with a vacuum zone of the mower when in an edging position. In a retracted position, the edger is withdrawn fully inboard of the outer periphery of the mover housing such that no projections are left to interfere with close-in mowing. Guards are provided for the edging disk when in a stowed position, and in an edging position. An alternate embodiment provides for lifting the edger over obstruction when the edger is used on a riding mower. A trim position for trimming around foundations and the like is provided, together with methods of edging.

U.S. Pat. No. 4,896,488 by Duncan et al. discloses a grass trimming attachment for a power lawn mower is provided that is mounted to extend from one side of the lawn mower and driven by the engine. The attachment can be pivoted upwardly and held against the lawn mower out of its normal operating position.

U.S. Pat. No. 5,560,189 by Devillier et al. discloses a mower assembly for cutting, trimming, and edging a lawn. The inventive device includes a mower assembly having a blade rotating within a horizontal plane for cutting grass. A trimmer assembly extends laterally of the mower assembly for trimming grass. An edger assembly similarly projects laterally of the mower assembly and includes an edging blade rotating in a vertical plane for cutting grass adjacent a solid object.

U.S. Patent Application Number 20040122725 by Womack discloses a growth strategy and implementation system and method. In particular, there is a system and method for generating a strategic marketing plan for growing and/or retaining customers in an industry, which may be realized by conducting behavior examination for one or more customers based on a recency factor, a frequency factor and a monetary factor; segmenting the one or more customers into a segment set based on a score, wherein the score comprises a value associated with the recency factor, the frequency factor and the monetary factor; assessing a customer need through a qualitative assessment and a quantitative assessment; and generating a strategic marketing plan based at least in part on the steps of conducting, segmenting and assessing.

U.S. Patent Application Number 20020087412 by Wood discloses a method for post-sales customer retention offers merchants an effective means by which to retain customers while providing customers with a simple, centralized service whereby they can keep track of their product purchases and information pertaining to such purchases, such as warranty information and repair history of products. A service according to one embodiment of the present invention offers merchants a centralized customer product information service. The centralized product information service comprises a collection of customer databases. The service further provides access to these customer databases to the merchants' customers.

The inventions heretofore known suffer from a number of disadvantages which include failing to provide sufficient incentive to a customer to remain in a product line, failing to appropriately suggest additional purchases, failing to provide convenient repair services, unfairly providing warrantee protection, providing multi-implement systems that are too difficult to utilize with a single motor, failing to maintain implements in good condition, etc.

What is needed is a system and/or a method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems and methods. Accordingly, the present invention has been developed to provide a system and method of retaining customers.

In one embodiment, there is a system and method of retaining a customer. There may be steps including: providing a first motor to a customer; providing a first implement to a customer, wherein the first implement is removably coupleable to the first motor without need for any tools; and/or offering for sale the second implement to a customer, wherein the second implement does not include any motor and is removably coupleable to the first motor without need for any tools.

Steps may also include: providing a storage device removably coupleable to the first implement and/or to the second implement, wherein the first implement and the second implement may each include a folded storage mode wherein the first implement and/or the second implement have a low aspect ratio; providing a suggestive indicator suggesting purchase of the second implement; providing a third implement, wherein the third implement is removably coupleable to the first motor without need for any tools; providing a fourth implement, wherein the fourth implement is removably coupleable to the first motor without need for any tools; gathering statistical data regarding demand for a plurality of implement types; determining a set of four implement types having the greatest demand; and/or wherein each of the first implement, the second implement, the third implement, and the fourth implement belong to the set of four implement types and do not substantially overlap implement type. A set of four implement types may include a lowest ranked implement type and the second implement may be not a lowest ranked implement type. The first implement, the third implement, and the fourth implement may be provided together in a single transaction.

Additional steps may include: providing a second motor having an output shaft extending vertically therefrom, wherein the second motor has an output shaft extending horizontally therefrom; and/or providing a third implement wherein the third implement is removably coupleable to the second motor without need for any tools and wherein the third implement receives power along a substantially horizontal axis.

The storage device may include second portion to which the second implement is removably coupleable; a visual indicator in association with the second portion, the visual indicator including a representation suggesting the second implement; and/or a winch device removably coupleable to the first motor.

The second implement may be offered at a price substantially lower than average motorized implements of the same implement type.

There may be steps of: exchanging the first motor for a second motor having substantially similar characteristics to the first motor; and/or accessing a motor data module including data relating to the first motor.

The first motor may include a visual representation of the second implement.

A step may include terminating a warrantee covering the first motor upon a usage threshold, wherein the first motor includes a usage meter configured to measure usage.

Also, steps may include: recording providing the first motor to an identified customer; recording providing the first implement to the identified customer; and/or conditionally offering a benefit to the identified customer upon purchase of the second implement. A benefit may include a warrantee extension for the first motor.

There may be a system for retaining a customer, including: a first motor; a storage device including: a first portion removably coupleable to the first implement, a second portion removably coupleable to the second implement, and/or a motor lift removably coupleable to the first motor; a suggestive indicator, coupled to one of the group consisting of the first motor and the storage device, configured to suggest to an observer's mind suggested implement type; and/or a first implement, not of the suggested implement type, removably coupleable to the first motor without need for any tools. There may also be a motor data module configured to store data relating to the first motor.

There may also be a repair system including a second motor, substantially identical to the first motor, such that the first motor can be replaced by the second motor should the first motor fail.

There may also be a motor transport system including a motor stand having: a motor coupling member configured to removably couple to a bottom of the motor; and/or a standoff member extending from the motor coupling member and configured to support the motor coupling member at a distance from a surface. There may also be a motor work bench similarly adapted to couple to and support a motor and configured to facilitate repair of the motor.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a method of retaining a customer according to one embodiment of the invention;

FIG. 2 illustrates a block diagram of a system for retaining a customer according to one embodiment of the invention;

FIG. 3 illustrates a block diagram of a repair system for retaining a customer according to one embodiment of the invention;

FIG. 4 illustrates a method of retaining a customer according to one embodiment of the invention;

FIG. 5 illustrates a perspective view of a motor having a visual representation according to one embodiment of the invention; and

FIG. 6 illustrates a front elevational view of a system for retaining customers according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The term “implement” or “host implement” and the like are herein defined as defined in U.S. Pat. No. 6,922,981 to Tyree (“the 981 patent”), which is hereby incorporated by reference herein.

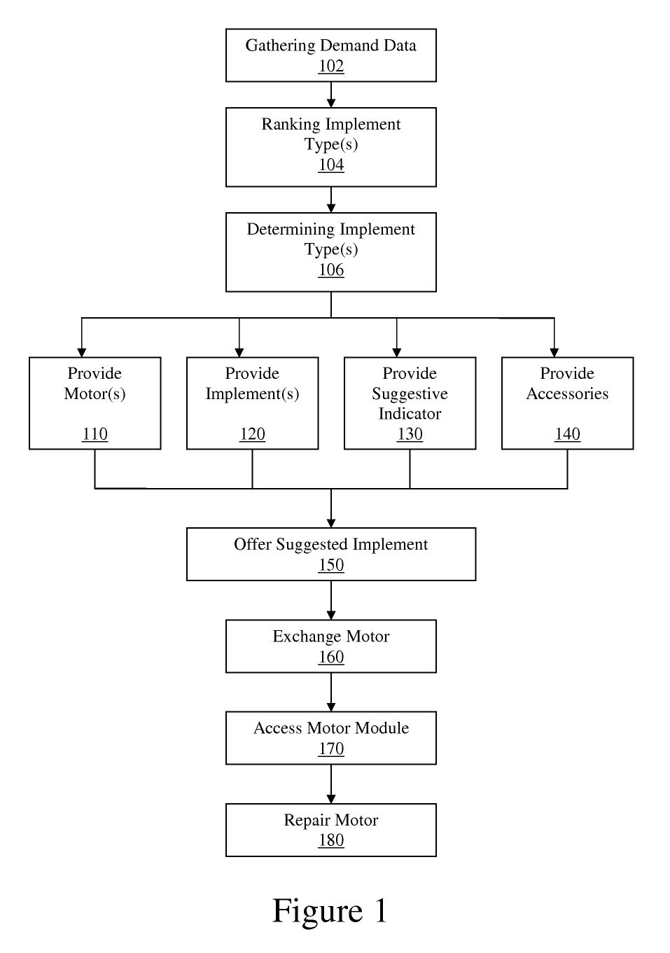

FIG. 1 illustrates a method of retaining a customer according to one embodiment of the invention. In the illustrated embodiment, demand data is gathered 102, then implement types are ranked 104 in association with the gathered demand data. Implement types are selected 106 to be made available to consumers. Then one or more motors are provided 110; one or more implements are provided 120; zero or more suggestive indicators are provided 130; and zero or more accessories are provided 140. Having at least one implement and at least one motor, the consumer is able to utilize the provided implement according to its function and purpose by coupling the motor thereto and operating the implement. A suggested or second implement is offered to the consumer to compliment the motor and implement. The consumer advantageously may purchase the second implement, may remove the motor from the implement without tools, and may install the motor on the second implement, also without tools. The motor may be easily exchanged 160. The provider may advantageously access a motor module 170 including information regarding the motor. The motor may be repaired 180. Thereby the consumer is enabled to take advantage of the many efficiencies available by use of such a system. The implement provider is advantageously able to retain a customer at the purchase of the second implement, as purchase of the second implement provides substantial advantages.

As used herein, “consumer” and “customer” include retail entities such as individuals and entities and also include businesses and wholesale entities. Nonlimiting examples include: implement rental businesses, home owners, landscaping businesses, etc.

Demand data may include any information relating to customer demand associated with an implement type. As a non-limiting example, a survey may be provided to consumers asking what implements they already own. In another non-limiting example, real estate listings may be reviewed and analyzed to determine what kinds of implements are likely to be needed by home purchasers. Lawn size, presence of trees and shrubs, usage of implements by neighbors may all be indicators of likely demand.

Implement types may be differentiated according to treatment in commerce, may be differentiated according to purpose, and/or may be differentiated according to user type. The following are non-limiting exemplary implement types: examples of light commercial implements include pumps, winches, hoists, and portable conveyors; examples of lawn and garden implements include grass mowers, including walk-behind mowers, riding mowers and pull behind mowers, tillers, cultivators, edgers, brush cutters, grass trimmers, mulcher/chippers, wood splitters, trenchers, lawn vacs, post hole diggers, power washers, and snow blowers; examples of home shop implements include air compressors, saws, including table saws and radial saws, drills, welders, wood lathes, and grinder/sanders; and examples of recreational implements include all terrain vehicles, bikes, boats, and ski mobiles.

Using the demand data, implement types may be ranked 104 according to demand. Once ranked (i.e. most demand, second most demand, etc.) implement types may be selected 106 to be provided 120 to a consumer/customer.

In one non-limiting example, a set of four highest ranked implement types may be selected relying on the demand data. The implements may be provided 120, through gift, sale, prize offering, etc., according to ranking. In one embodiment, one of the top ranked implements may not be provided, thereby not fulfilling a likely need on the consumer that received one or more other implements. The un-provided implement may be offered for purchase by the consumer, upon which the need is fulfilled. Further, wherein an implement without a motor costs a provider substantially less than an associated implement with a motor, a consumer may much more easily purchase the desired implement.

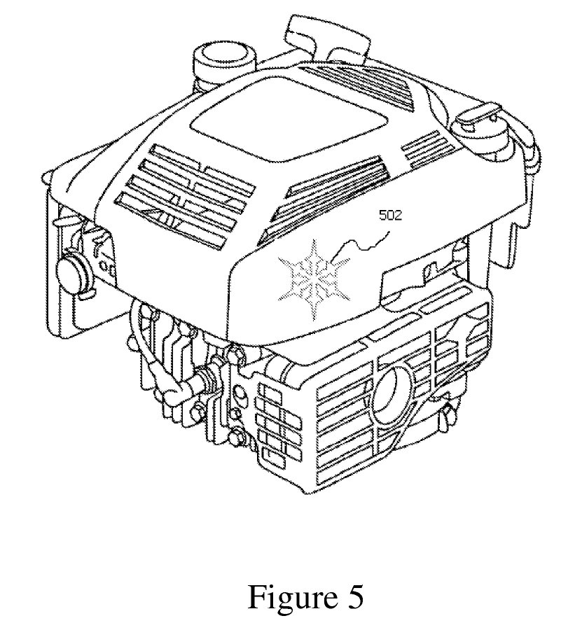

Additionally, together with the provided motor and/or implement, there may be provided 130 a suggestive indicator that may provide a repeated visual purchase suggestion associated with the second/suggested implement. Such may be a visual display on the motor and/or implement that may be configured to direct a consumer's thoughts to the function, shape, benefit, etc. of the second/suggested implement. FIG. 5 provides a non-limiting example of such.

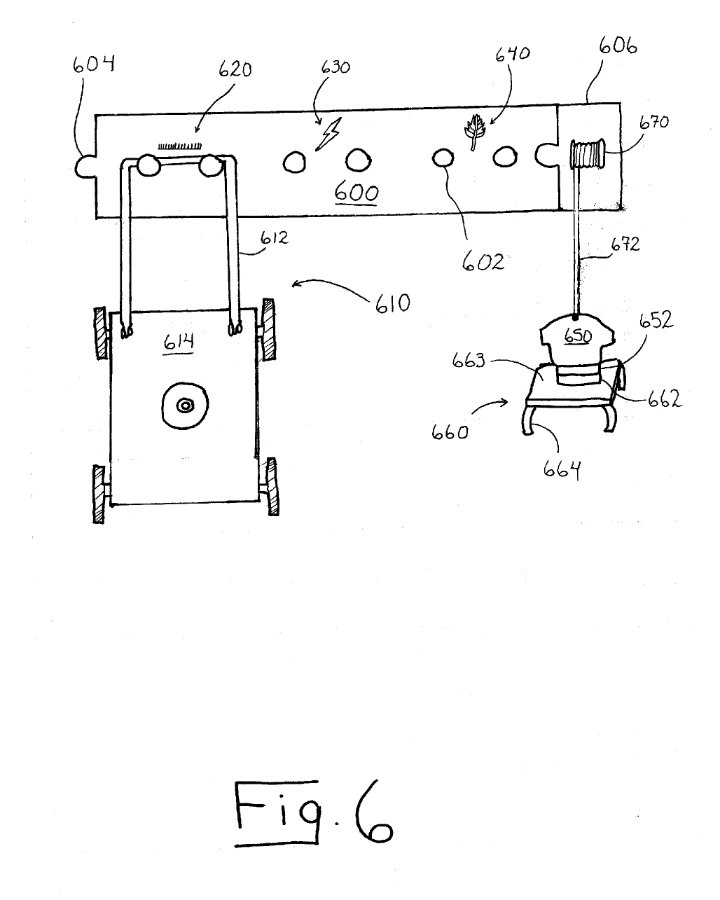

Additionally, accessories may be provided 140, such as those shown in FIG. 6.

Further, a provider may also retain a customer at a failure (or other similar problem) of a motor, wherein a provider may simply exchange 160 a functioning motor (new, repaired, refurbished, etc.) for the motor of the consumer. The provider may access a motor module 170 that may include data regarding the motor, including but not limited to repair history, troubleshooting guide, owner history, maintenance history, manufacturer notes/suggestions, etc. Such information may come from customers, industry experts, employees or agents of the provider, repair personnel, etc. Such information may assist in repairing 180 the motor and/or in designing future versions of the motor. Advantageously, by keeping a customer within the system, the product may be enhanced, thereby further increasing incentive for the customer to remain associated with the provider.

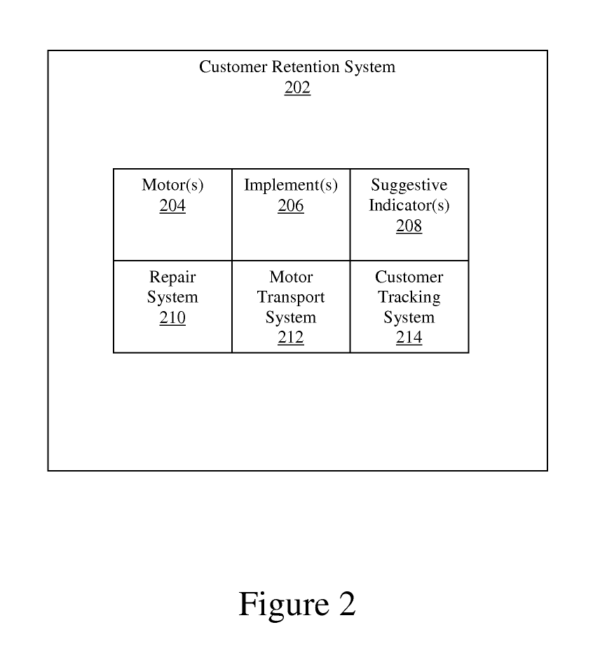

FIG. 2 illustrates a block diagram of a system for retaining a customer according to one embodiment of the invention. There is shown one or more motors 204, one or more implements 206, one or more suggestive indicators 208, a repair system 210, a motor transport system 212, and a customer tracking system 214. The system may be used by an implement provider to retain customers as customers make additional purchases.

The motor(s) 204 may be any kind of motor known in the art. Non-limiting examples include horizontal and vertical motors (motors that provide an output power shaft intended to be disposed horizontally/vertically when in use), electric motors (AC/DC, 12 volt motors, ½ volt motors, etc., such as but not limited to those used in golf carts, boats, etc.), etc. A motor 204 may include a handle coupled thereto. The handle may be heat resistant and/or configured to restrict heat flow therethrough from the motor. Accordingly, the handle may advantageously permit a user to lift and carry a motor, for example, from one implement to another, without the awkwardness associated with carrying a hot motor without a handle.

The motor may include structure sufficient to enable a user to removably couple the motor to an implement without use of tools. Exemplary tools include: screwdrivers, wrenches, pliers, etc. Occasional use of tools under abnormal conditions such as when a coupling is rusted together does not violate the “without tools limitation.” Further, use of a safety device, such as a kill-switch pin inserted during coupling is not considered a “tool” as used herein. A motor may include an hour meter such as an ENM T49 Electronic LCD Hour Meter of ENM Company of 5617 Northwest Highway Chicago, Ill. 60646-6135.

As used herein, a substantially similar motor is a motor having sufficient characteristics that it may be interchanged with another motor and successfully operate the same implement(s) as the other motor.

A non-limiting example of a motor/implement system removably coupleable without use of tools is provided in the 981 patent. The motor(s) 204 may be provided in a set, such as but not limited to a single horizontal motor, a single vertical motor, and a single electric motor. Such a motor set, and sets similar thereto, may enable a consumer to advantageously adapt motor types to the needs of the moment and may enable a consumer to purchase specialized implements. For example, a snow blower implement may be adapted to function with a horizontal motor and a lawnmower may be adapted to function with a vertical motor. Additionally, a user may rely on an electric motor when it may be inconvenient to use another motor (such as a gas powered motor) such as where gas may be expensive, a user may have run out of gas, a user may prefer a quieter operation at the moment, etc. Exemplary motor providers include: Briggs & Stratton of Milwaukee, Wis. and General Electric of Fairfield, Conn.

The implement(s) 206 may include any known in the art, such as those previously described. An implement 206 may include structure sufficient to allow a consumer to couple the implement to a motor 204 of the system 202 without tools, such that the motor 204 may power operation of the implement 206. Non-limiting examples of such implements may be found in the 981 patent.

The customer retention system 202 may include one or more suggestive indicator(s) 208. As used herein, “suggestive indicator” includes an image suggestive of an implement type. A suggestive indicator may be included in one or more portions of the customer retention system 202, such as but not limited to a motor 204 and/or a implement 206. Non-limiting examples of suggestive indicators include: a visible relief of a snowflake on an exterior of a motor 204 suggesting a snow blower implement, a sticker showing a stream of fluid coupled to a visible portion of a motor transport system 212 suggesting a pressure-washer implement, and a sculpted go-cart figurine visibly presented near a handle of a lawnmower implement suggesting a go-cart implement. Clearly, the variety of suggestive indicators is plethoric.

Advantageously, a consumer is reminded of the suggested implement upon each viewing of the suggestive indicator. Accordingly, a desire to acquire the suggested implement may be developed and/or reinforced by use of the system. Further, in one embodiment, a suggestive indicator may be alterable upon purchase of the suggested implement, such as but not limited to replacing the suggestive indicator with another, and covering the suggestive indicator with another indicator, such as but not limited to a check mark, thereby providing a sense of collection/collectibles to the consumer.

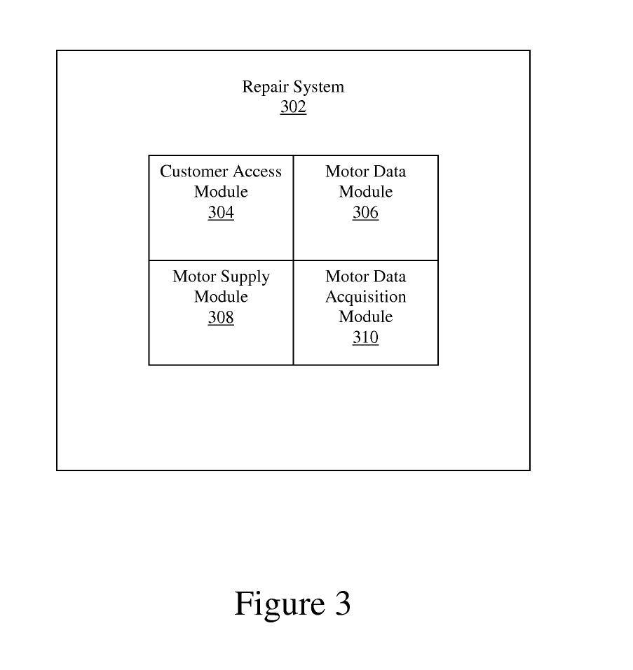

The repair system/module 210 enables a provider (or associate of the provider) to retain the customer in cases of less than desired operation of one or more portions of the customer retention system 202. In the illustrations and description, attention is devoted to a repair system providing repair of one or more motors. However, it is understood that a repair system may provide repair to one or more portions of the customer retention system in addition to or instead of motors. For example, a repair system may provide repair to one or more implements. See FIG. 3 for additional description.

The motor transport system 212 may be provided as a motor accessory. A motor transport system 212 may include one or more devices for enabling storage and/or transportation of a motor 204. Exemplary portions of a motor transportation system 212 are illustrated in FIG. 6 (see stand 660 and winch device 670). Advantageously, a consumer having a motor transportation system 212 may help protect a motor 204 from wear and tear during storage and/or travel, such but not limited to keeping a motor upright, stabilized, disposed at a distance from surfaces, etc. Further, such may also protect other items from damage by the motor. Accordingly, transporting a motor to a job location or repair shop may be facilitated.

The customer tracking system/module 214 enables a provider to record and retrieve information regarding a customer and/or portion of the customer retention system, such as but not limited to a particular motor or implement. The customer tracking module may include a database and/or data storage. In one non-limiting example, there is a hard-drive in communication with a server running MySQL of Cupertino, Calif. Accordingly, purchase information may be associated with a particular customer. Demand data may be mined therefrom. A suggestive indicator may be attached to a purchased implement according to information in the customer tracking module.

In one non-limiting example, a customer already owns a motor, host lawnmower and host leaf blower and purchases a host snow blower implement. The customer tracking module may provide information to the provider such that the provider does not attach a suggestive indicator suggesting purchase of a lawnmower (as the customer already owns a lawnmower) and/or attaches a suggestive indicator suggesting purchase of a host implement likely to be needed by the customer according to an analysis of the already owned implements and comparison with similar buying patterns of other customers.

FIG. 3 illustrates a block diagram of a repair system 302 (see Repair System 210, FIG. 2) for retaining a customer according to one embodiment of the invention. There is shown a customer access module 304, a motor data module 306, a motor supply module 308, and a motor data acquisition module 310. Through the repair system 302, a customer may be provided quick and efficient repair/replacement of one or more portions of the customer retention system. Wherein a repair system 302 may be directed to additional/alternative portions of a customer retention system, the word “motor” as used in the description of FIG. 3 may be replaced and/or amended as required with such portions.

The customer access module 304 enables a customer to access the repair system 302. In one embodiment a customer access module 304 includes a kiosk that may be disposed in a retail facility, such as a hardware store. A customer access module 304 may include a computer readable medium in association with one or more portions of the customer retention system, such as a magnetic strip, barcode, etc. that may be read by the repair system and associated with a particular customer or particular customer retention system.

The motor data module 306 includes data associated with a motor, including purchase data (date of purchase, amount, purchase location, etc.), motor-type data (model, parts list, recommended maintenance, best repair practices, etc.), motor history (repair logs, etc.), etc. There may be a database for managing such data. In one embodiment, there is a software module including script and MySQL statements. There may be a GUI, such as may be provided in a windowed environment such as in Windows® by Microsoft Corporation of Redmond, Wash.

The motor supply module 308 enables a repair system to maintain an appropriate supply of motors and/or motor parts. A motor supply module may enable a repair system to order additional motors and/or motor parts. There may be a module configured to receive order data for a geographical (or otherwise appropriately subdivision) area, such that a repair system may anticipate repair demand. Statistical data may be gathered and factors, such as weather, may be integrated with the module, such that the motor supply module may suggest an increase or a decrease in orders relating to an expected increase or decrease in repair demand. There may be an RSS feed receivable by the motor supply module that may include information relating to repair demand and/or expected repair demand.

The motor data acquisition module 310 gathers information relating to repair of motors. A motor data acquisition module may keep track of typical repairs performed at a repair system and or other repair related data and may associate such data with one or more factors, such as but not limited to motor source (who manufactured which motor), weather, time of year, previous repairs made to the motor, identity of technicians who have worked on the motor. Accordingly, a motor data acquisition module may gather data relevant to improving product and/or repair quality and may automatically look for correlations. A motor data acquisition module may include one or more portions of code that may include script and SQL statements. A motor data acquisition module may incorporate algorithms generally used in the field of statistics to find correlations between data sets.

Advantageously, a customer retention system may provide significant and substantial benefits to the environment. In particular, wherein motors generally provide a certain amount of pollution and/or waste associated just with the motor being produced and being used with a single implement, such waste and pollution is eliminated for multiple motors where a single motor is used for a plurality of implements. Further, storage waste and pollution and disposal waste and pollution are similarly reduced. More, wherein a repair system is part of a customer retention system, repair and disposal pollution may be substantially eliminated as best practices may be implemented at the repair system as opposed to individual motor owners performing repairs and disposing of motors as they each see fit.

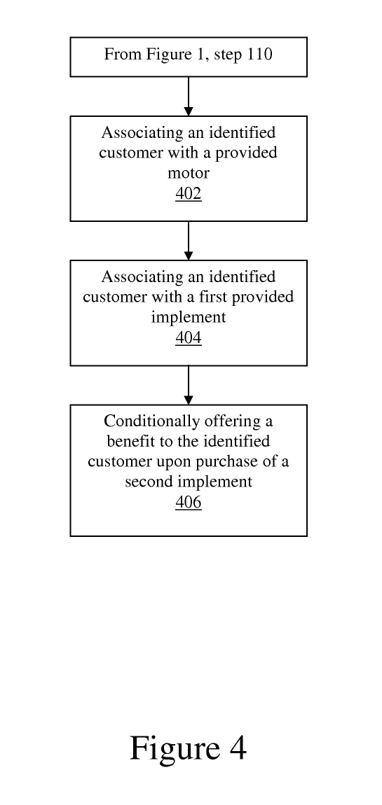

FIG. 4 illustrates a method of retaining a customer according to one embodiment of the invention. In particular, an identified customer is associated 402 (such as in a database) with a provided motor. The identified customer is also associated 404 with a first provided implement. Then a conditional offering is made 406 offering a benefit to the identified customer upon purchase of a second or suggested implement. In one embodiment, a benefit includes a warrantee extension on the first motor. A provider may be justified in doing such, wherein use of the first and second implements may induce better usage of the motor, such that the motor may naturally have a longer life. In one non-limiting example, a first implement may be an implement generally used in the summer, such as a lawnmower, and the second implement may be an implement generally used in the winter (such as a snow blower). Accordingly, the single motor will be utilized year round and is less likely to sit idle for many months. Therefore, the motor is less likely to suffer from degradation and a longer warrantee may be extendable at a small cost to the provider. It is envisioned that the variety of benefits are plethoric.

FIG. 5 illustrates a perspective view of a motor having a visual representation according to one embodiment of the invention. Shown is a single motor detached from an implement. On the surface of the motor is a suggestive indicator 502, which suggests the use of the motor with a particular implement. For example, in the illustrated Figure, a snowflake is shown, which suggests use of the motor with a snow blower. However, in another embodiment of the invention, a single motor may have a variety of suggestive indicators suggesting use with a variety of different implements.

FIG. 6 illustrates a front elevational view of a system for retaining customers according to one embodiment of the invention. As illustrated, there is a storage device 600 for storing implements and motors. The storage device 600 has a storage module coupling portion 604 which allows the storage device 600 to couple to another storage device 600. As shown, the storage module coupling portion 604 is a U-shaped tongue corresponding to a U-shaped groove on another storage device 600. However, one skilled in the art would know that tongue and groove joints have a variety of shapes, such as: S-shaped, Z-shaped, etc., and combinations thereof.

The storage device 600 also has a storage portion 602 for removably coupling implements to the storage device 600 by hanging. Illustrated is a host lawn mower 610 removably coupled to the storage device 600 by hanging the mower handle 612 on a plurality of storage portions 602. In preparation for storing, the host lawn mower 610 may be positioned in a folded storage mode by rotating the mower handle 612 around the host lawnmower base 614 until the mower handle 612 is substantially parallel to the host lawn mower base 614, and the host law mower 610 is substantially flat. In addition, one skilled in the art would know that a variety of implements may be similarly stored in a folded storage mode. Storing implements in a folded storage mode would be advantageous because: a folded implement takes up less space than an unfolded implement which would free up additional storage space; and a folded implement is less likely to be knocked off the storage device or struck than one that protrudes.

In addition, the storage device 600 also includes a plurality of suggestive indicators which correlate to an appropriate implement. As illustrated, the suggestive indicators suggest various implements, such as: a patch of grass 620, which suggests a lawnmower; a lightening bolt 630, which suggests a power generator; and a leaf 640, which suggests a leaf blower. However, one skilled in the art would know that a variety of other suggestive indicators could also be used to suggest other implements, such as: a snowflake, which suggests a snow blower; a blade, which suggests a hedge trimmer; a saw, which suggests a chainsaw; etc.

Coupled to the storage device 600 is a second storage module 606. The second storage module 606 has a winch device 670 which extends outwardly from the second storage module 606. The winch device 670 allows for storage of a motor 650 by attaching of a flexible member/cable 672 to the motor 650, and winching the flexible member around the winch device 670.

A transportation system or motor stand 660 is also coupled to the motor 650 for easily and safely transporting the motor 650 to a desired implement or other location. The transportation system 660 has a transportation coupling member 662 for coupling to a motor coupling member 652. The transportation system 660 also has a support member 663 for supporting the weight of the motor 650 during transport. In addition, the transportation system 660 has legs 664 for additional support and/or height.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate a particular order for steps to take place, it is understood that steps may occur in a great variety of different orders and are to be limited only by orders explicitly described in the claims.

Additionally, although the figures illustrate particular devices having particular shapes, coupling mechanisms, numbers of parts, etc., it is understood that the invention may be practiced in a great variety of modes including a great variety of different devices, shapes, coupling mechanisms, numbers of parts, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method of retaining a customer, comprising the steps of:
providing a first motor to a customer;
providing a first implement to a customer, wherein the first implement is removably coupleable to the first motor without need for any tools; and
offering for sale the second implement to a customer, wherein the second implement does not include any motor and is removably coupleable to the first motor without need for any tools.

2. The method of claim 1, further comprising providing a storage device removably coupleable to the first implement and to the second implement, and wherein the first implement and the second implement each include a folded storage mode wherein the first implement and the second implement have a low aspect ratio.

3. The method of claim 1, further comprising providing a suggestive indicator suggesting purchase of the second implement.

4. The method of claim 1, further comprising:
providing a third implement, wherein the third implement is removably coupleable to the first motor without need for any tools;
providing a fourth implement, wherein the fourth implement is removably coupleable to the first motor without need for any tools;
gathering statistical data regarding demand for a plurality of implement types;
determining a set of four implement types having the greatest demand; and
wherein each of the first implement, the second implement, the third implement, and the fourth implement belong to the set of four implement types and do not substantially overlap implement type.

5. The method of claim 4, wherein set of four implement types includes a lowest ranked implement type and the second implement is not a lowest ranked implement type.

6. The method of claim 1, further including the steps of:
providing a second motor having an output shaft extending vertically therefrom, wherein the second motor has an output shaft extending horizontally therefrom; and
providing a third implement wherein the third implement is removably coupleable to the second motor without need for any tools and wherein the third implement receives power along a substantially horizontal axis.

7. The method of claim 2, wherein the storage device includes second portion to which the second implement is removably coupleable and wherein the storage device includes a visual indicator in association with the second portion, the visual indicator including a representation suggesting the second implement.

8. The method of claim 2, wherein the storage device includes a winch device removably coupleable to the first motor.

9. The method of claim 1, wherein the second implement is offered at a price substantially lower than average motorized implements of the same implement type.

10. The method of claim 1, further comprising the steps of:
further comprising the step of exchanging the first motor for a second motor having substantially similar characteristics to the first motor; and
accessing a motor data module including data relating to the first motor.

11. The method of claim 1, wherein the first motor includes a visual representation of the second implement.

12. The method of claim 1, further comprising terminating a warrantee covering the first motor upon a usage threshold, wherein the first motor includes a usage meter configured to measure usage.

13. The method of claim 1, further comprising:
recording providing the first motor to an identified customer;
recording providing the first implement to the identified customer; and
conditionally offering a benefit to the identified customer upon purchase of the second implement.

14. The method of claim 13, wherein the benefit includes a warrantee extension for the first motor.

15. The method of claim 4, wherein the first implement, the third implement, and the fourth implement are provided together in a single transaction.

16. A method of retaining a customer, comprising the steps of:
providing a first motor to a customer;
providing a first implement to a customer, wherein the first implement is removably coupleable to the first motor without need for any tools;
offering for sale a second implement to a customer, wherein the second implement does not include any motor and is removably coupleable to the first motor without need for any tools;
providing a third implement, wherein the third implement is removably coupleable to the first motor without need for any tools;
providing a storage device removably coupleable to the first implement and to the second implement;
gathering statistical data regarding demand for a plurality of implement types;
determining a set of three implement types having the greatest demand;
wherein each of the first implement, the second implement, and the third implement belong to the set of three implement types and do not substantially overlap implement type; and
wherein the storage device includes second portion to which the second implement is removably coupleable and wherein the storage device includes a visual indicator in association with the second portion, the visual indicator including a representation suggesting the second implement.

17. A system for retaining a customer, comprising:
a first motor;
a storage device including:
a first portion removably coupleable to the first implement;
a second portion removably coupleable to the second implement; and
a motor lift removably coupleable to the first motor;
a suggestive indicator, coupled to one of the group consisting of the first motor and the storage device, configured to suggest to an observer's mind suggested implement type; and
a first implement, not of the suggested implement type, removably coupleable to the first motor without need for any tools.

18. The system of claim 17, further comprising:
a repair system including a second motor, substantially identical to the first motor, such that the first motor can be replaced by the second motor should the first motor fail.

19. The system of claim 18, further comprising a motor transport system including a motor stand having:
a motor coupling member configured to removably couple to a bottom of the motor; and
a standoff member extending from the motor coupling member and configured to support the motor coupling member at a distance from a surface.

20. The system of claim 18, wherein the repair system further includes a motor data module configured to store data relating to the first motor.
